(19) United States
(12) Patent Application Publication
(10) Pub. No.: US 2026/0040095 A1
(43) Pub. Date: Feb. 5, 2026

(54) Coordinated Compute and Communication Control

(71) Applicant: Dell Products L.P., Round Rock, TX (US)

(72) Inventors: Hoda Dehghan, Toronto (CA); Gwenael Poitau, Montreal (CA)

(21) Appl. No.: 18/795,106

(22) Filed: Aug. 5, 2024

(51) Int. Cl. H04W 24/02

(52) U.S. Cl. CPC H04W 24/02

(57) ABSTRACT

A system can comprise a communications interface between a radio access network domain of a broadband cellular network and a compute domain, and at least one memory that stores executable instructions that, when executed by the at least one processor, facilitate performance of operations. These operations can comprise receiving, at the radio access network domain and via the communications interface, first information relating to operation of the broadband cellular network from the compute domain. These operations can further comprise determining, by the radio access network domain, a near-real time action to take with respect to the operation of the broadband cellular network based on the first information and second information relating to operation of the broadband cellular network from the radio access network domain. These operations can further comprise implementing the near-real time action.

### BACKGROUND

A base station of a broadband cellular network can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. A system can comprise a communications interface between a radio access network domain of a broadband cellular network and a compute domain. The system can comprise at least one processor, and at least one memory that stores executable instructions that, when executed by the at least one processor, facilitate performance of operations. These operations can comprise receiving, at the radio access network domain and via the communications interface, first information relating to operation of the broadband cellular network from the compute domain. These operations can further comprise determining, by the radio access network domain, a near-real time action to take with respect to the operation of the broadband cellular network based on the first information and second information relating to operation of the broadband cellular network from the radio access network domain. These operations can further comprise implementing the near-real time action to take with respect to the operation of the broadband cellular network.

An example method can comprise, obtaining, at a radio access network domain and via a communications interface of a system comprising at least one processor, first information relating to operation of a broadband cellular network from a compute domain, wherein the broadband cellular network comprises the radio access network domain, the compute domain, and the communications interface between the radio access network domain and the compute domain. The method can further comprise obtaining, at the radio access network domain, second information pertaining to the operation of the broadband cellular network from the radio access network domain. The method can further comprise determining, by the radio access network domain, an action to take with respect to the operation of the broadband cellular network based on the first information and the second information. The method can further comprise in response to the determining, facilitating, by the system, performance of the action.

An example non-transitory computer-readable medium can comprise instructions that, in response to execution, cause a system comprising a processor to perform operations. These operations can comprise, obtaining, at a radio access network domain and via a communications interface, first information relating to operation of a broadband cellular network from a compute domain. These operations can further comprise obtaining, at the radio access network domain, second information pertaining to the operation of the broadband cellular network from the radio access network domain. These operations can further comprise determining, by the radio access network domain, an action to take with respect to the operation of the broadband cellular network based on the first information and the second information. These operations can further comprise initiating performance of the action with respect to the operation of the broadband cellular network.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate coordinated compute and communication control, in accordance with an embodiment of this disclosure;

FIG. 2 illustrates another example system architecture that can facilitate coordinated compute and communication control, in accordance with an embodiment of this disclosure;

FIG. 3 illustrates an example signal flow that can facilitate coordinated compute and communication control, in accordance with an embodiment of this disclosure;

FIG. 4 illustrates another example system architecture that can facilitate coordinated compute and communication control, in accordance with an embodiment of this disclosure;

FIG. 5 illustrates an example process flow that can facilitate coordinated compute and communication control, in accordance with an embodiment of this disclosure;

FIG. 6 illustrates another example process flow that can facilitate coordinated compute and communication control, in accordance with an embodiment of this disclosure;

FIG. 7 illustrates another example process flow that can facilitate coordinated compute and communication control, in accordance with an embodiment of this disclosure;

FIG. 8 illustrates another example process flow that can facilitate coordinated compute and communication control, in accordance with an embodiment of this disclosure;

FIG. 9 illustrates another example process flow that can facilitate coordinated compute and communication control, in accordance with an embodiment of this disclosure; and

FIG. 10 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies, and more generally to wireless communications.

In the network optimization landscape, a challenge can arise from disjointed operations between radio access network (RAN) controllers and compute controllers. Historically managed as separate entities, this division can lead to inefficiencies in resource allocation, increased latency, and suboptimal network performance. The present techniques can be implemented to facilitate an architecture centered around a nrX11 interface, which can facilitate near-real-time data exchange between RAN and compute domains. Leveraging this interface, the architecture can empower RAN controllers with insights into computational resources and can enhance decision-making, resulting in adaptive resource allocation. The integration of multi-domain data can enable predictive analytics and proactive resource management, transforming the network into a user-centric, efficient, and responsive system. This synergetic reference architecture can address the challenges of some cellular networks (such as fifth generation (5G) networks.

In the landscape of optimization, one area that can stand at the forefront of innovation and efficiency is coordinated compute and communication optimization. This concept, which can be rooted in the domain of distributed computing and network systems, can revolve around a strategic enhancement of both computational processes and communication protocols to improve overall system performance. This optimization can lie in not just advancing individual elements, but in harmonizing an interplay between computation and communication.

Distributed computing systems, where tasks are distributed across multiple computing nodes, can exemplify a need for such coordinated optimization. compute optimization in this context can refer to refining the utilization of computational resources such as central processing unit (CPU) and graphics processing unit (GPU) resources, optimizing memory allocation, application deployment and/or initiation, and also enhancing data processing efficiency. Parallelly, communication optimization can focus on an aspect of data transfer between network nodes, aiming to minimize latency, maximize bandwidth usage, and/or optimize data routing strategies.

Coordinated optimization can comprise a recognition that advancements in computational processes can significantly influence communication demands, and vice versa. For instance, streamlining computation can inadvertently increase the frequency or volume of data transfers, necessitating a balanced approach. This interdependency can present a multitude of challenges, such as dealing with a heterogeneity of resources across different nodes, navigating the complexities of modern network architectures, and/or striking an equilibrium between compute and communication efficiencies.

Furthermore, as systems scale, maintaining this balance can become an increasingly arduous task. The challenges can be compounded in scenarios that involve real-time constraints, where immediate data processing and transfer can be imperative. Another aspect that can add to the complexity is a need for energy-efficient solutions, especially in large-scale operations like data centers.

Prior approaches have shortcomings. One significant limitation is an absence of universal optimization strategies, owing to the diverse requirements of various system architectures and applications. The implementation of coordinated optimization strategies can often be marred by complexity and high resource demands. Moreover, systems can request or need to exhibit a degree of real time adaptability to fluctuating workloads and network conditions, which can be challenging. Inadequate optimization can lead to bottlenecks, in computation and/or communication, thus impeding the system's overall efficiency. Additionally, continuous monitoring and maintenance ensures the long-term effectiveness of these strategies.

Coordinated compute and communication optimization can be an important and complicated endeavor in the realm of distributed computing. It can demand a detailed understanding of both computational dynamics and network behavior. Despite the challenges and inherent complexities, effective optimization strategies can yield substantial improvements in system performance. However, a foundational step to achieving this coordinated optimization can be an establishment of an architecture that enables such a strategy. It can be that this architecture must be designed to facilitate efficient data exchange between domain controllers, addressing the type of data exchange, the protocols involved, and/or the overall system topology. It can be requested, or need, to support seamless communication and computation workflows, ensuring that both elements are not only optimized individually but also work cohesively.

It can be appreciated that the present techniques can generally be applied to multi-domain control platforms.

A problem with modern telecommunications infrastructure can relate to synchronization between RAN controllers and compute controllers. These pivotal components within the network's ecosystem can be designed to fulfill distinct functions and have historically been managed as separate entities. This division has led to an inefficiency in their operation, manifesting as a barrier to achieving optimal network performance. The underlying issue can be traced back to the lack of an integrated architectural framework that can accurately articulate the interdependencies that exist between the RAN and compute domains. Without such a framework, there is a disconnect in the optimization process, which can hinder the network's ability to operate at maximum efficiency and performance levels.

The current segmentation between the RAN and compute controllers can mean that the RAN controllers focus on managing and optimizing radio resources without considering the state of computational resources. Conversely, compute controllers can manage the allocation and maintenance of computing resources without visibility into the RAN's conditions. This disjointed operation can lead to a scenario where resource allocation is far from ideal, with potential repercussions such as increased latency in data transmission, a drop in the data throughput, and a decrease in service quality. It can be that these are not mere inconveniences, but are critical flaws that can affect user experience and the perceived reliability of the network.

Additionally, this isolated functioning of controllers can prevent a seamless flow of vital operational data, specifically performance indicators and state information, that can be crucial for making informed and strategic decisions. IN some examples, RAN controllers, which can benefit from insights into computational load and performance, are instead restricted to metrics pertaining to radio frequency and signal quality. On the flip side, compute controllers can operate with a limited dataset that focuses solely on the performance of computational tasks and the status of computing resources, remaining unresponsive to the real-time requests, needs and challenges of the RAN.

This compartmentalization can become particularly challenging as telecommunications networks become more complicated with the introduction and expansion of 5G technologies. These newer generations of mobile networks introduce an array of advanced services and applications that require an unprecedented level of dynamic and agile management of resources. The various services enabled by 5G, such as enhanced mobile broadband (cMBB), ultra-reliable low-latency communications (URLLC), and massive machine type communications (mMTC), can each come with their own set of demands on both RAN and compute resources. The ability to efficiently cater to these diverse and sometimes conflicting requirements can be paramount for network operators who aim to provide the best service quality while also maintaining economic viability.

That is, as networks evolve to accommodate a broader spectrum of services and handle more complex tasks, the absence of an architecture that fully integrates RAN and compute controllers can increasingly be a problem. It can not only limit the effectiveness of current network operations but also hinder the potential for future advancements. A holistic view of the network's operational state can be beneficial and sometimes critical, not just for the optimization of existing processes, but also for the incorporation of emergent technologies that can define the future of telecommunications. Without addressing this issue, network operators can risk falling behind in an industry that is rapidly progressing towards more integrated and intelligent systems.

A near-real time X1 (nrX1) interface can facilitate near-real-time (near-RT) interaction of compute and communication domains (e.g., interactions between a RIC and a compute controller). A purpose of the nrX1 interface can be to provide coordination between the RIC and the compute controller, allowing for efficient and dynamic adjustments based on near-RT data. In some examples, nrX1 interface can provide data to a service management and orchestration (SMO) framework for non-real-time (non-RT) optimization.

Relative to prior approaches, this can enable more responsive and adaptive network management, leveraging compute domain information to fine-tune the operation of the RAN domain, and vice versa.

The present techniques can be implemented to facilitate enhanced coordination. A nrX1 interface can enable a new level of dynamic coordination between the RIC and the compute controller, allowing for adjustments based on near-RT data. This can enhance an adaptability and responsiveness of a network, where in prior approaches it can be that this is not possible.

A nrX1 interface according to the present techniques can support non-RT data provision to a SMO for optimization purposes, and facilitate near-RT coordination, in a manner not offered by prior approaches. This dual functionality can facilitate both immediate network adjustments and long-term optimization strategies.

The present techniques can facilitate optimized (or improved) network operations. By leveraging compute domain information in a near-RT domain, the nrX1 interface can allow for more precise and efficient network operations. This can include dynamic resource allocation.

Integrating RAN and compute domains can present technical challenges due to the complexity of the task. Historically, these domains have evolved separately, each developing specialized technologies and protocols tailored to their specific needs. As a result, creating an interface that harmonizes these disparate systems can involve overcoming substantial technical hurdles related to compatibility and interoperability. This integration can involve a deep understanding of both RAN and compute areas to ensure that the systems can work together seamlessly.

Achieving near-real time data exchange between RAN and compute controllers can be another technical challenge. This can involve low-latency communication and efficient data processing to ensure timely and accurate information transfer. The level of synchronization required for near-real-time exchange can be difficult to attain, especially in large-scale and dynamic network environments where conditions can change rapidly and unpredictably. Ensuring that data reflective of current network conditions is always available for decision-making processes can add another layer of complexity.

Furthermore, it can be that the nrX1 interface must be scalable to accommodate growing network demands and an increasing complexity of modern telecommunications infrastructure. As networks expand and the volume of data increases, it can be that the interface must be able to handle large amounts of data without performance degradation. Ensuring scalability while maintaining efficiency and responsiveness can be a considerable challenge, which can require robust design and implementation strategies to manage the anticipated growth in data traffic and computational load.

Before the emergence of new use cases, it can be that there was no clear need to optimize compute and communication simultaneously. However, with emerging verticals and use cases in 5G, this need has become evident. For instance, enhanced Mobile Broadband (cMBB) can require high data rates and low latency to support applications like augmented reality (AR) and virtual reality (VR). Ultra-Reliable Low-Latency Communications (URLLC) can be essential for mission-critical applications such as autonomous driving and remote surgery, where any delay in communication can have severe consequences. Massive Machine Type Communications (mMTC) can involve connecting a large number of Internet-of-Things (IOT) devices, which can necessitate efficient data processing and communication management to handle the sheer volume of connections and data processing.

These use cases can illustrate a benefit of coordinated optimization of compute and communication resources to meet the stringent performance requirements of 5G networks. The demand for high-speed data transmission and processing, real-time responsiveness, and reliable connectivity in these verticals can underscore a benefit of developing and implementing a nrX1 interface according to the present techiques in the telecommunications industry.

### Example Architectures and Signal Flow

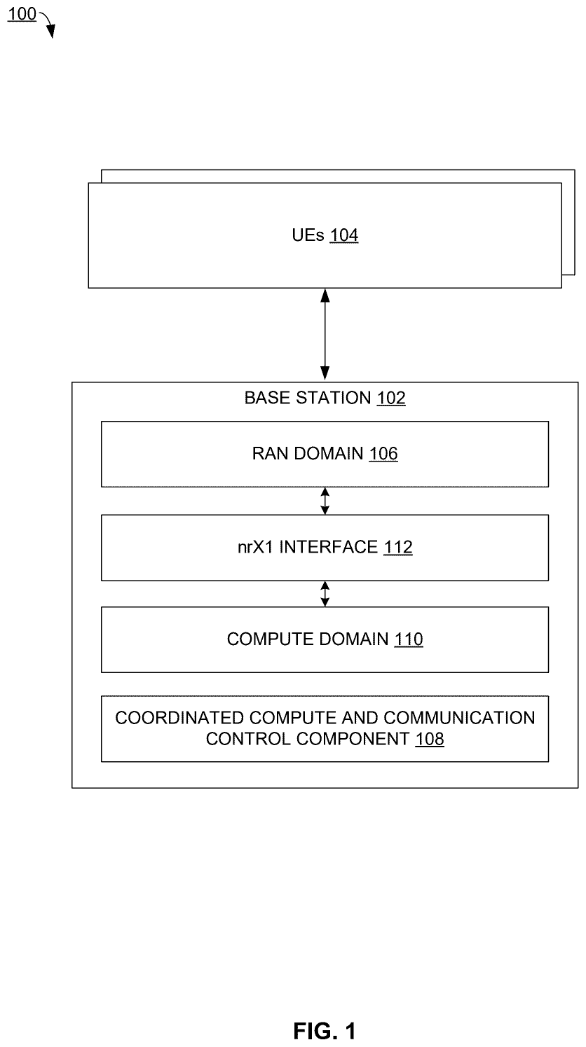

FIG. 1 illustrates an example system architecture 100 that can facilitate coordinated compute and communication control, in accordance with an embodiment of this disclosure.

System architecture 100 comprises base station 102 and UEs 104. In turn, base station 102 comprises RAN domain 106, coordinated compute and communication control component 108, compute domain 110, and nrX1 interface 112.

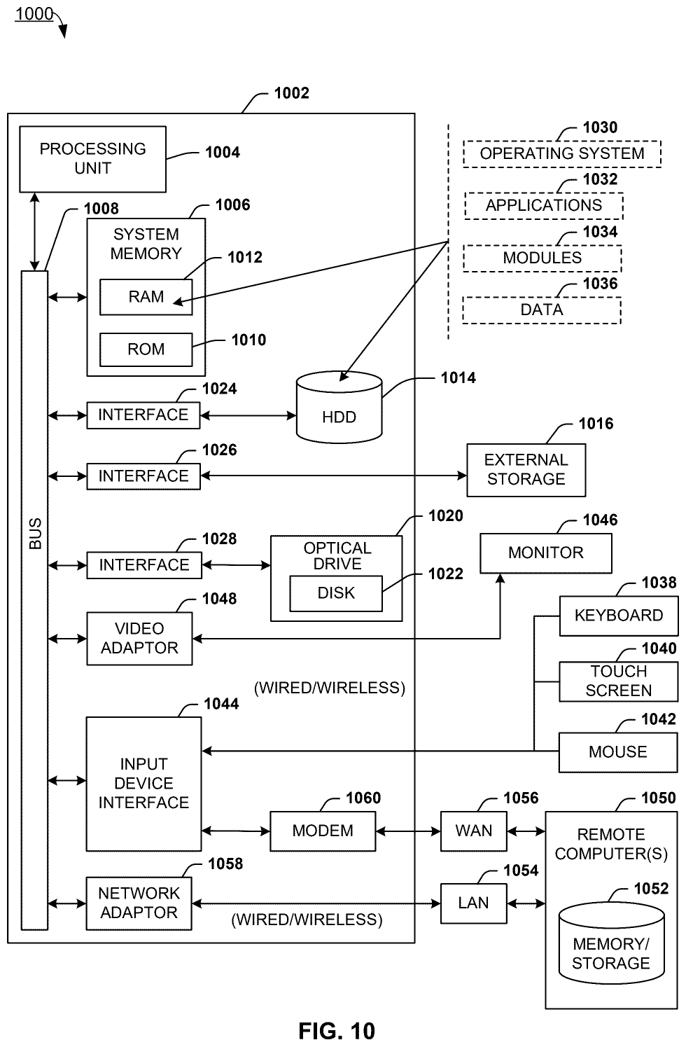

Each of base station 102 and/or UEs 104 can be implemented with part(s) of computing environment 1000 of FIG. 10.

Base station 102 can comprise two domains—RAN domain 106 and compute domain 110—which can operate on data as part of facilitating broadband cellular communications. In controlling operation of base station 102, coordinated compute and communication control component 108 can use information from both RAN domain 106 and compute domain 110 (and received via nrX1 interface 112) to make near-real time decisions as to the operation of base station 102. In some examples, coordinated compute and communication control component 108 can be implemented in a RIC in compute domain 110.

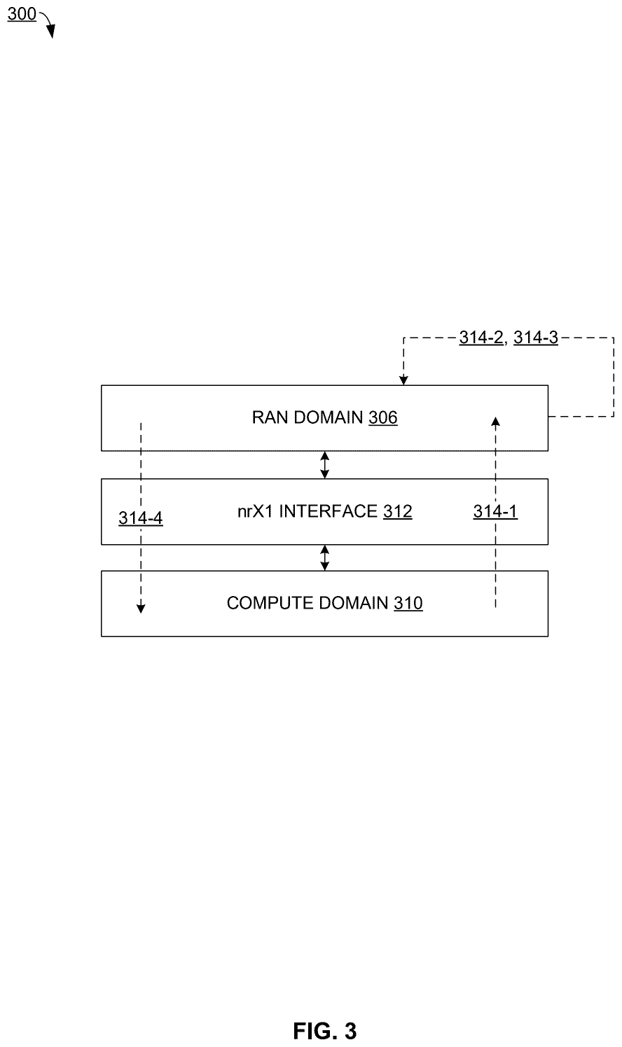

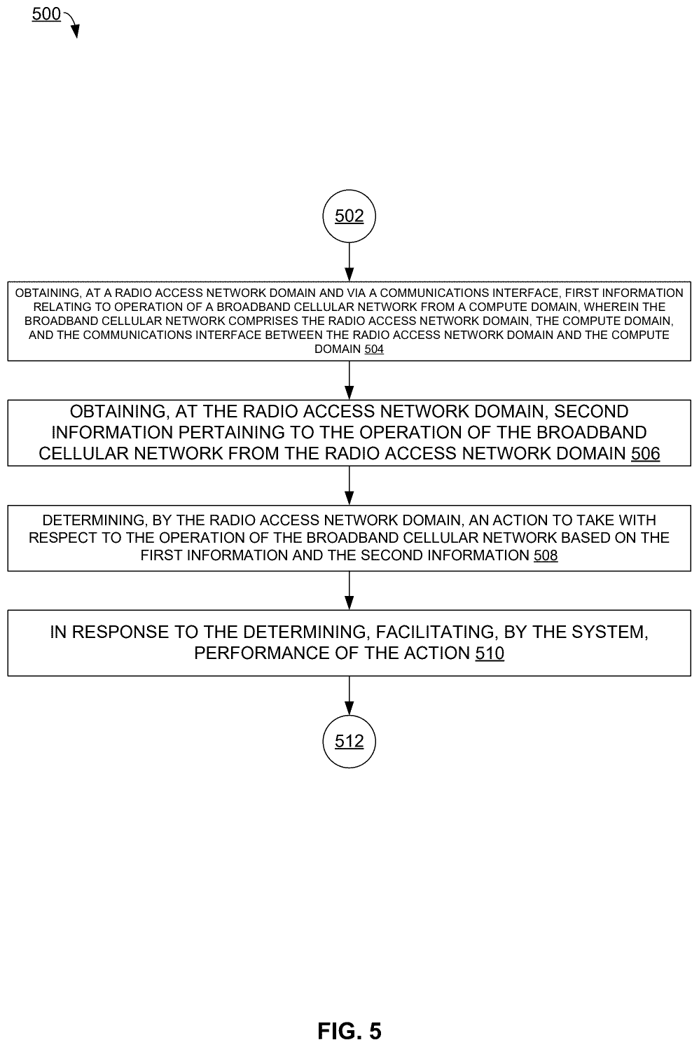

In some examples, coordinated compute and communication control component 108 can implement part(s) of the signal flow of FIG. 3 and/or the process flows of FIGS. 5-9 to facilitate coordinated compute and communication control.

It can be appreciated that system architecture 100 is one example system architecture for coordinated compute and communication control, and that there can be other system architectures that facilitate coordinated compute and communication control.

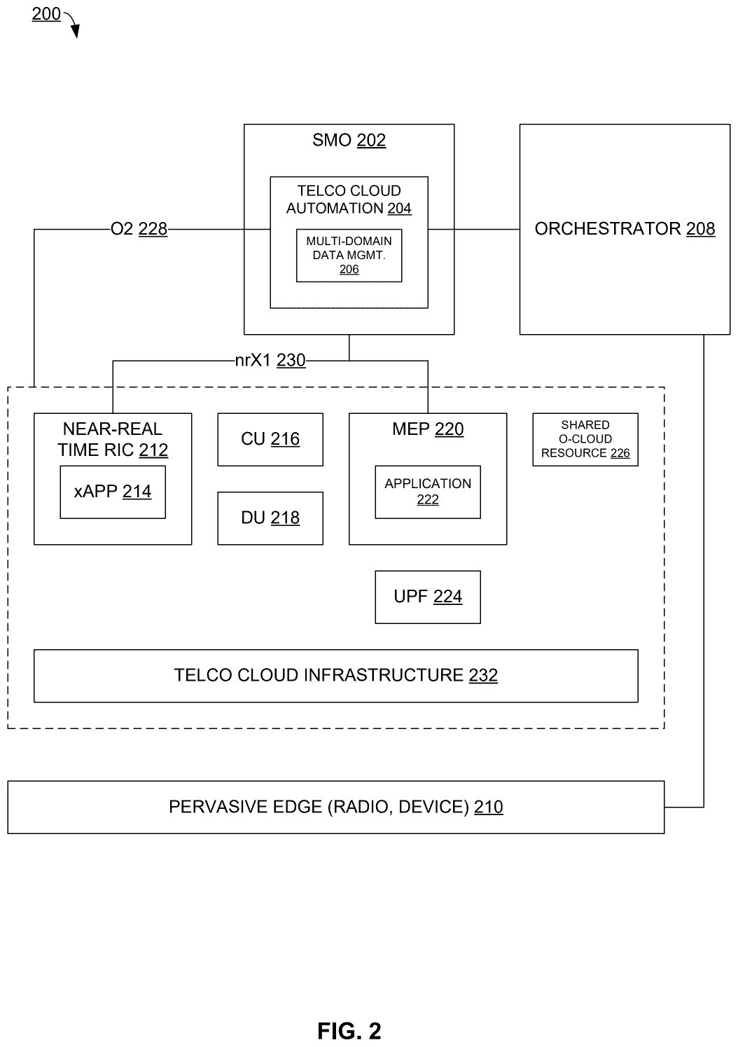

FIG. 2 illustrates another example system architecture 200 that can facilitate coordinated compute and communication control, in accordance with an embodiment of this disclosure. In some examples, part(s) of system architecture 200 can be implemented by part(s) of system architecture 100 of FIG. 1 to facilitate coordinated compute and communication control.

System architecture 200 comprises service management and orchestration (SMO) 202, telco cloud automation 204, multi-domain data management 206, orchestrator 208, pervasive edge (radio, device) 210, near-real time RIC 212, xApp 214, centralized unit (CU) 216, distributed unit (DU) 218, mobile edge platform (MEP) 220, application 222, user plane function (UPF) 224, shared o-cloud resource 226, O2 228, nrX1 230, and telco cloud infrastructure 232.

In some examples, the present techniques can be implemented as follows. In the landscape of modern telecommunications, an example architecture shown in FIG. 2, can serve as a solution to challenges posed by the prior-approach disjointed operations between RAN controllers and compute controllers.

This example architecture can incorporate an interface known as nrX1. This interface can act as a backbone of the architectural design, facilitating a seamless and convenient exchange of information between the RAN and compute domains. The functionality of nrX1 can be designed to allow the near-real-time exchange of state information and key performance indicators (KPIs), which can be integral to the efficient and timely management of network operations.

A nrX1 interface can bridge a previously-existing gap between the RAN and compute entities. A function can be to provide a reliable and rapid conduit for data (e.g., state/KPI) transfer, enabling the sharing of vital operational metrics and states between the RAN and compute controllers. This interface can facilitate an information exchange between the RAN controller (such as the RAN intelligent controller (RIC)) and the compute controller at a near-real-time level. This transfer can be continuous, and can also occur with minimal latency, ensuring that data reflective of the current network conditions is always available for decision-making processes.

Empowering the RAN and compute controllers through data integration can be implemented as follows. With the implementation of nrX1, the RAN controller, which can be exemplified by the RIC, can gain a substantial enhancement in its decision-making capabilities. Leveraging the combined insights from both RAN and compute KPIs and states, the RIC can be equipped to conduct more refined and adaptive resource allocation. This enriched dataset can provide the RIC with a holistic view of the network's operational state, thereby enabling it to make more informed choices regarding the deployment of computational resources. This capability can be transformative, as it can allow the RIC to not only react to current network conditions but also to anticipate future states based on computational load and performance trends. Such predictive resource management can be crucial for maintaining network quality, especially in high-demand scenarios.

For example, when determining a most suitable (or suitable) computing node for deploying an application, the RIC can now consider the current load and performance of the RAN in tandem with the available computational capabilities. This integrative approach can ensure that decisions are made in a manner that aligns with real-time network demands, leading to an optimization of both the user experience and network performance.

Furthermore, the integration of RAN KPIs/states with computing resource information can enhance the efficiency of computing node selection or scheduling for deploying a target application. Moreover, by modifying the models that describe computing nodes to include RAN attributes, a more detailed and accurate profile of these nodes can be created. In prior approaches, it can be that these models might only include factors like CPU speed, memory, and storage. But now, they can also reflect how the nodes relate to the RAN—such as their ability to handle data traffic or their proximity to users. This can create a more complete picture of each node's capabilities and how they fit into the broader network, leading to smarter decisions about where to run different pieces of software. That is, by considering both computing and RAN attributes, the whole system can work more efficiently and effectively.

Automation and efficiency in a telecommunications (sometimes referred to as telco) cloud can be implemented as follows. An architecture according to the present techniques can introduce a heightened level of automation within a telco cloud environment. An architecture according to the present techniques can elevate automation capabilities within the telecommunications cloud environment by leveraging access to a comprehensive set of data across different domains. This multi-faceted data can streamline numerous processes, and can enhance an efficiency of operations such as the retraining of both xApps (which can comprise software applications that run on the near-real time (RT) RIC to manage RAN behavior) and applications on a mobile edge platform (MEP).

The RIC can play a crucial role in this ecosystem by gathering and synthesizing data from interactions between the RAN and compute controllers. It can then forward this aggregated data to cloud-based telecom automation systems. This data transfer can be particularly geared toward functions that do not require real-time processing, commonly referred to as non-RT purposes. These non-RT tasks can include, but are not limited to, the retraining of xApps and MEP applications, which can operate at the edge of a network to optimize service delivery. The data sent by the RIC can be used to inform rApps (which can generally comprise applications running in the non-RT RIC layer) to produce control commands that are not time sensitive.

By integrating these data-driven insights into the non-RT processes, an architecture according to the present techniques can ensure that the network can adapt to changing conditions and optimize its operations continuously. This approach can not only enhance a performance of the RAN, but also ensure that the computational resources are used efficiently, leading to a more responsive and robust telecommunications network.

It can be that this level of automation does not merely streamline network operations; it can also drastically reduce a need for manual interventions. By automating routine tasks and decision-making processes, the architecture can free up valuable human resources to focus on more strategic initiatives. Furthermore, a shift towards an automated environment can set the stage for the implementation of more complex and sophisticated network management strategies.

Streamlining operations can be implemented as follows. A unified data approach brought forth by the nrX1 interface can simplify and enhance network operations. This streamlined process can be a departure from a previous situation where RAN and compute controllers operated in silos. The shared knowledge base can enable a more cohesive operational strategy, allowing for the synchronization of tasks and the harmonious functioning of the network.

A synergistic reference architecture according to the present techniques can be implemented as follows. Such an architecture can include an integrated control framework that comprises a nrX1 interface. This integration can represent a significant shift from prior approaches to network management, where RAN and compute controllers operate as separate silos. The nrX1 interface can facilitate cooperation between these controllers, fostering a more harmonious and synchronized network. This unified framework can facilitate bridging the two domains, leading to a holistic management strategy that improves overall network performance and is adaptive to the complex requests and needs of modern telecommunications.

An architecture according to the present techniques can facilitate near-RT information exchange. This functionality can enhance the network's responsiveness by allowing for the quick transfer of state information and KPIs, which can be critical for the adaptive management of network resources. Unlike previous systems that can rely on periodic updates or batch processing, the near-RT exchange can facilitate a dynamic and agile network environment. This immediate data exchange can be particularly important for 5G (and newer) networks, where conditions can change rapidly, requiring equally rapid responses to maintain service levels.

An architecture according to the present techniques can facilitate dynamic optimization of resources. By sharing KPIs and state information across RAN and computational resources, the architecture can enable a more efficient use of the entire network. This can be a departure from prior approaches that optimized these resources in isolation, often leading to inefficiencies and sub-optimal performance. A model according to the present techniques can ensure that both radio access and computational power are utilized to their fullest potential (or a fuller potential relative to prior approaches), aligning resource management with the real-time demands of network traffic and user requests and needs. This optimization can not only conserve valuable resources, but can also enhance the user experience by providing a more stable and robust network service.

Inclusion of multi-domain data can be implemented as follows. Multi-domain data can encompass a wide range of information spanning various aspects of a telecom network. In cloud orchestration, this data can converge from disparate sources, including user equipment, RAN, transport, and/or core networks. By harnessing this data, telecom operators can gain insights into network performance, user behavior, and/or service demand patterns. This comprehensive view can enable the automation systems to make more intelligent decisions, such as predicting network load and proactively adjusting resources to meet demand.

An architecture according to the present techniques can facilitate enhancing cloud orchestration with multi-domain data. In the context of cloud orchestration, multi-domain data can serve as a foundation for a coordinated compute and communication framework. This framework can be predicated on an idea that computational resources and communication pathways must be managed in tandem to deliver services that are both responsive and cost-efficient.

For instance, when orchestrating cloud resources, understanding the state of the RAN can dictate where to best deploy a virtual network function (VNF) or how to route traffic to minimize latency. If the RAN is experiencing high traffic, compute resources can be allocated closer to the network edge to alleviate congestion and reduce the strain on the core network.

An architecture according to the present techniques can facilitate predictive analytics and proactive management. A power of multi-domain data can lie in its potential for predictive analytics. By analyzing trends across the RAN, transport, and core, as well as UE data, it can be that the network can forecast future states with remarkable accuracy. This foresight can enable the network to shift from a reactive to a proactive management stance, allocating resources before a demand surge or rerouting traffic in anticipation of a bottleneck.

For communication, predictive analytics can adjust RAN parameters ahead of expected load increases, such as those caused by a scheduled event or detected by trends in user mobility. For compute, it can pre-emptively scale out cloud resources or initiate edge computing services to maintain performance levels.

An architecture according to the present techniques can facilitate user-centric network services. Multi-domain data can enable a user-centric approach to network services. By understanding user behavior, requests, and needs, the network can tailor services to different user segments. For high-value customers or critical services like emergency response, the network can prioritize resources to ensure high availability and resilience.

FIG. 3 illustrates an example signal flow 300 that can facilitate coordinated compute and communication control, in accordance with an embodiment of this disclosure. In some examples, part(s) of signal flow 300 can be implemented by part(s) of system architecture 100 of FIG. 1 to facilitate coordinated compute and communication control.

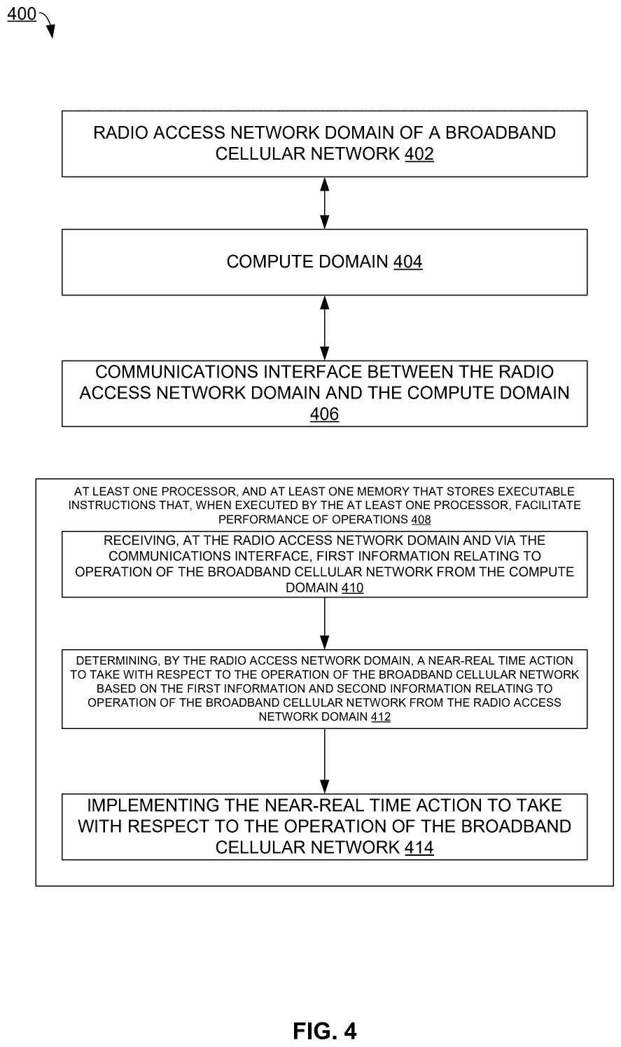

Signal flow 300 comprises RAN domain 306, compute domain 310, and nrX1 interface 312, which can be similar to RAN domain 106, compute domain 110, and nrX1 interface 112 of FIG. 1, respectively. Between and through the following signals are sent:
1. 314-1: this can comprise RAN domain 306 receiving information from compute domain 310 via nrX1 interface 312, and can be similar to operation 410 of FIG. 4.
2. 314-2: this can comprise RAN domain 306 determining information about the RAN domain, and can be similar to operation 412 of FIG. 4.
3. 314-3: this can comprise RAN domain 306 determining an action to take for its broadband cellular network based on the information from 314-1 and 314-2, and can be similar to operation 412 of FIG. 4.
4. 314-4: this can comprise RAN domain 306 effectuating the action of 314-3, and can be similar to operation 414 of FIG. 4. In 314-4, this is depicted as an action taken in compute domain 310, and it can be appreciated that the action can be taken in other parts of a broadband cellular network, such as within RAN domain 306.

FIG. 4 illustrates another example system architecture that can facilitate coordinated compute and communication control, in accordance with an embodiment of this disclosure. In some examples, part(s) of system architecture 200 can be implemented by part(s) of system architecture 100 of FIG. 1 to facilitate coordinated compute and communication control.

System architecture comprises radio access network domain of a broadband cellular network 402, compute domain 404, communications interface between the radio access network domain and the compute domain 406, and at least one processor, and at least one memory that stores executable instructions that, when executed by the at least one processor, facilitate performance of operations 408. These operations can be operations 410-414.

Using the example of FIG. 1, the radio access network domain can be similar to RAN domain 106, the compute domain can be similar to compute domain 110, and the communications interface can be similar to nrX1 interface 112.

Operation 410 depicts receiving, at the radio access network domain and via the communications interface, first information relating to operation of the broadband cellular network from the compute domain.

In some examples, the first information is received from a compute controller of the compute domain.

In some examples, the first information comprises an indication of a performance of a computational task or a status of computing resources.

Operation 412 depicts determining, by the radio access network domain, a near-real time action to take with respect to the operation of the broadband cellular network based on the first information and second information relating to operation of the broadband cellular network from the radio access network domain.

In some examples, the second information is received from a radio access network controller of the radio access network domain.

In some examples, the second information comprises an indication of radio frequency quality or signal quality.

In some examples, the second information comprises a key performance indicator.

In some examples, the second information is received from an xApp in a near-real time controller of the radio access network domain.

In some examples, the near-real time action to take with respect to the operation of the broadband cellular network relates to operation of the radio access network domain.

In some examples, the near-real time action to take with respect to the operation of the broadband cellular network relates to operation of the compute domain.

Operation 414 depicts implementing the near-real time action to take with respect to the operation of the broadband cellular network.

### Example Process Flows

FIG. 5 illustrates an example process flow 500 for coordinated compute and communication control, in accordance with an embodiment of this disclosure. In some examples, one or more embodiments of process flow 500 can be implemented by system architecture 100 of FIG. 1, or computing environment 1000 of FIG. 10.

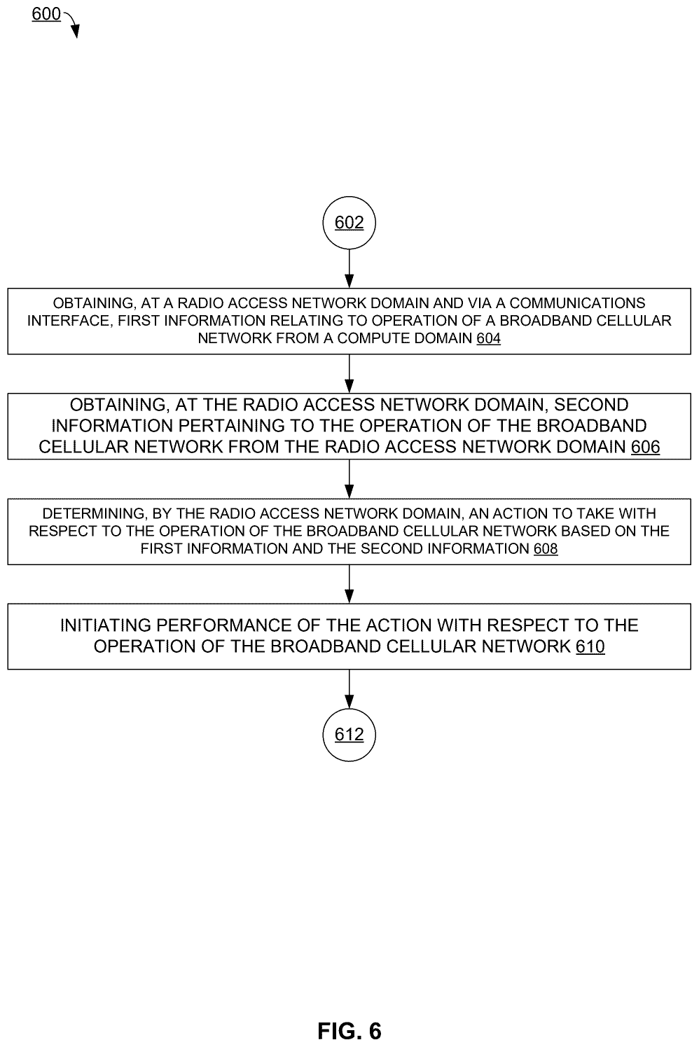

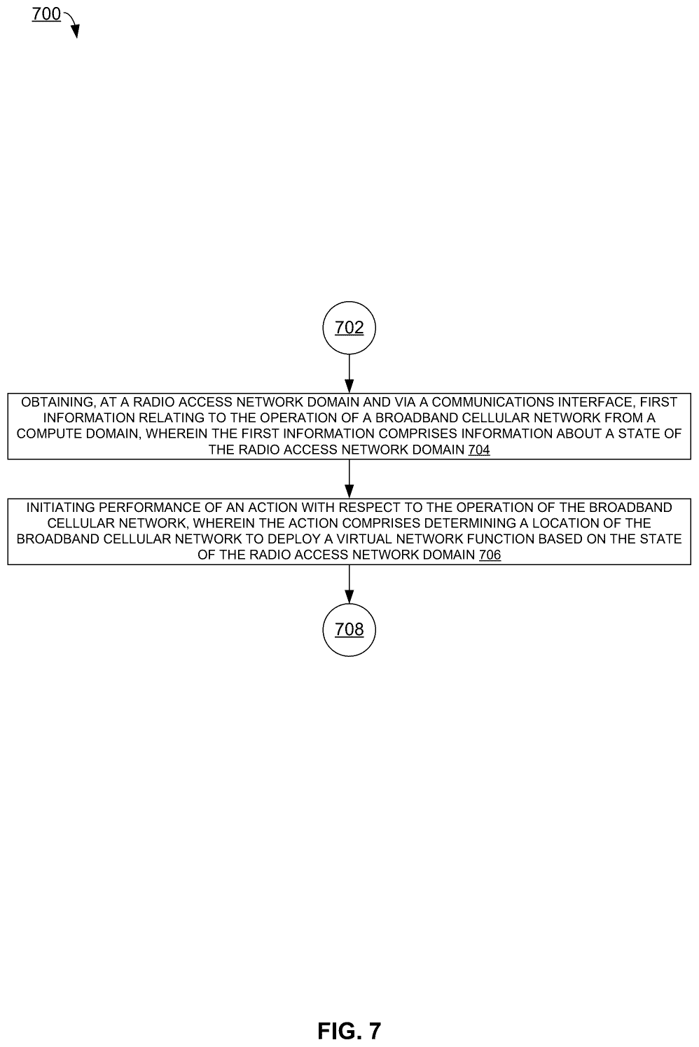

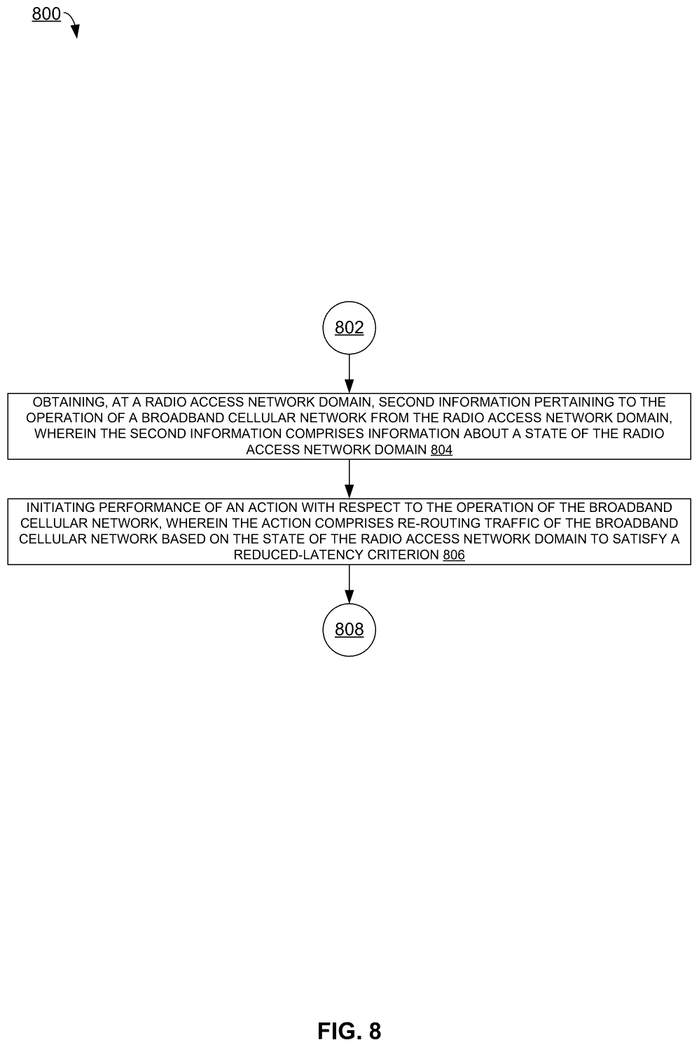

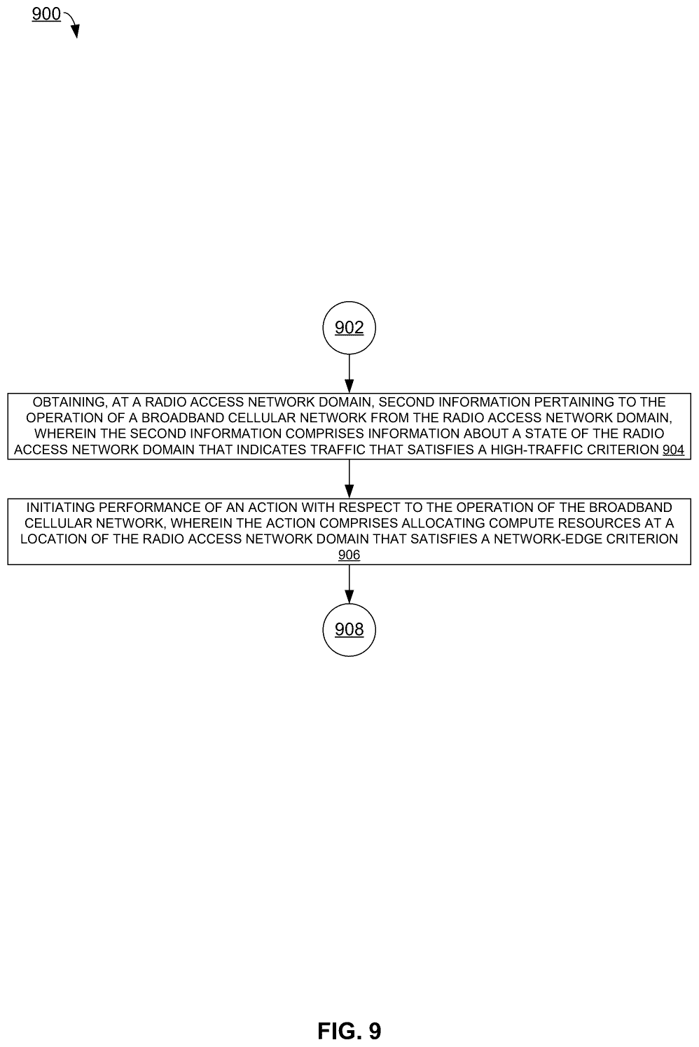

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts obtaining, at a radio access network domain and via a communications interface of a system comprising at least one processor, first information relating to operation of a broadband cellular network from a compute domain, wherein the broadband cellular network comprises the radio access network domain, the compute domain, and the communications interface between the radio access network domain and the compute domain. In some examples, this can be implemented in a similar manner as operation 410 of FIG. 4.

In some examples, the compute domain comprises a mobile edge platform.

After operation 504, process flow 500 moves to operation 506.

Operation 506 depicts obtaining, at the radio access network domain, second information pertaining to the operation of the broadband cellular network from the radio access network domain. In some examples, this can be implemented in a similar manner as operation 412 of FIG. 4.

In some examples, the second information comprises state information comprising at least one state value of the at least one first value applicable to a state of the broadband cellular network.

After operation 506, process flow 500 moves to operation 508.

Operation 508 depicts determining, by the radio access network domain, an action to take with respect to the operation of the broadband cellular network based on the first information and the second information. In some examples, this can be implemented in a similar manner as operation 412 of FIG. 4.

After operation 508, process flow 500 moves to operation 510.

Operation 510 depicts in response to the determining, facilitating, by the system, performance of the action. In some examples, this can be implemented in a similar manner as operation 414 of FIG. 4.

In some examples, the action comprises an instance of predictive resource management of the broadband cellular network. Empowering the RAN and compute controllers through data integration can be implemented as follows. With the implementation of nrX1, the RAN controller, which can be exemplified by the RIC, can gain a substantial enhancement in its decision-making capabilities. Leveraging the combined insights from both RAN and compute KPIs and states, the RIC can be equipped to conduct more refined and adaptive resource allocation. This enriched dataset can provide the RIC with a holistic view of the network's operational state, thereby enabling it to make more informed choices regarding the deployment of computational resources. This capability can be transformative, as it can allow the RIC to not only react to current network conditions but also to anticipate future states based on computational load and performance trends. Such predictive resource management can be crucial for maintaining network quality, especially in high-demand scenarios.

In some examples, the action comprises selecting a computing node of the radio access network domain for deployment of an application. For example, when determining a most suitable (or suitable) computing node for deploying an application, the RIC can now consider the current load and performance of the RAN in tandem with the available computational capabilities. This integrative approach can ensure that decisions are made in a manner that aligns with real-time network demands, leading to an optimization of both the user experience and network performance.

After operation 510, process flow 500 moves to 512, where process flow 500 ends.

FIG. 6 illustrates an example process flow 600 for coordinated compute and communication control, in accordance with an embodiment of this disclosure. In some examples, one or more embodiments of process flow 600 can be implemented by system architecture 100 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts obtaining, at a radio access network domain and via a communications interface, first information relating to operation of a broadband cellular network from a compute domain.

After operation 604, process flow 600 moves to operation 606.

Operation 606 depicts obtaining, at the radio access network domain, second information pertaining to the operation of the broadband cellular network from the radio access network domain.

After operation 606, process flow 600 moves to operation 608.

Operation 608 depicts determining, by the radio access network domain, an action to take with respect to the operation of the broadband cellular network based on the first information and the second information.

After operation 608, process flow 600 moves to operation 610.

Operation 610 depicts initiating performance of the action with respect to the operation of the broadband cellular network.

In some examples, the action comprises producing a control command via an rApp of the radio access network domain, and wherein the control command is time insensitive. That is, data sent by the RIC can be used to inform rApps (which can generally comprise applications running in the non-RT RIC layer) to produce control commands that are not time sensitive.

In some examples, the action comprises taking a predictive action regarding the radio access network domain or the compute domain. That is, an architecture according to the present techniques can facilitate predictive analytics and proactive management. A power of multi-domain data can lie in its potential for predictive analytics. By analyzing trends across the RAN, transport, and core, as well as UE data, it can be that the network can forecast future states with remarkable accuracy. This foresight can enable the network to shift from a reactive to a proactive management stance, allocating resources before a demand surge or rerouting traffic in anticipation of a bottleneck.

After operation 610, process flow 600 moves to 612, where process flow 600 ends.

FIG. 7 illustrates an example process flow 700 for coordinated compute and communication control, in accordance with an embodiment of this disclosure. In some examples, one or more embodiments of process flow 700 can be implemented by system architecture 100 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts obtaining, at a radio access network domain and via a communications interface, first information relating to the operation of a broadband cellular network from a compute domain, wherein the first information comprises information about a state of the radio access network domain. This can be implemented in a similar manner as operation 604 of FIG. 6.

After operation 704, process flow 700 moves to operation 706.

Operation 706 depicts initiating performance of an action with respect to the operation of the broadband cellular network, wherein the action comprises determining a location of the broadband cellular network to deploy a virtual network function based on the state of the radio access network domain. In some examples, operation 706 can be implemented in a similar manner as operation 610 of FIG. 6.

After operation 706, process flow 700 moves to 708, where process flow 700 ends.

In some examples, process flow 700 combines with process flow 600 of FIG. 6 such that the first information comprises information about a state of the radio access network domain, and the action comprises determining a location of the broadband cellular network to deploy a virtual network function based on the state of the radio access network domain.

FIG. 8 illustrates an example process flow 800 for coordinated compute and communication control, in accordance with an embodiment of this disclosure. In some examples, one or more embodiments of process flow 800 can be implemented by system architecture 100 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts obtaining, at a radio access network domain, second information pertaining to the operation of a broadband cellular network from the radio access network domain, wherein the second information comprises information about a state of the radio access network domain. This can be implemented in a similar manner as operation 606 of FIG. 6.

After operation 804, process flow 800 moves to operation 806.

Operation 806 depicts initiating performance of an action with respect to the operation of the broadband cellular network, wherein the action comprises re-routing traffic of the broadband cellular network based on the state of the radio access network domain to satisfy a reduced-latency criterion. In some examples, operation 806 can be implemented in a similar manner as operation 610 of FIG. 6.

After operation 806, process flow 800 moves to 808, where process flow 800 ends.

In some examples, process flow 800 combines with process flow 600 of FIG. 6 such that the second information comprises information about a state of the radio access network domain, and the action comprises re-routing traffic of the broadband cellular network based on the state of the radio access network domain to satisfy a reduced-latency criterion.

FIG. 9 illustrates an example process flow 900 for coordinated compute and communication control, in accordance with an embodiment of this disclosure. In some examples, one or more embodiments of process flow 900 can be implemented by system architecture 100 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts obtaining, at a radio access network domain, second information pertaining to the operation of a broadband cellular network from the radio access network domain, wherein the second information comprises information about a state of the radio access network domain that indicates traffic that satisfies a high-traffic criterion. This can be implemented in a similar manner as operation 606 of FIG. 6.

After operation 904, process flow 900 moves to operation 906.

Operation 906 depicts initiating performance of an action with respect to the operation of the broadband cellular network, wherein the action comprises allocating compute resources at a location of the radio access network domain that satisfies a network-edge criterion. In some examples, operation 906 can be implemented in a similar manner as operation 610 of FIG. 6.

After operation 906, process flow 900 moves to 908, where process flow 900 ends.

In some examples, process flow 900 combines with process flow 600 of FIG. 6 such that the second information comprises information about a state of the radio access network domain that indicates traffic that satisfies a high-traffic criterion, and the action comprises allocating compute resources at a location of the radio access network domain that satisfies a network-edge criterion.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of base station 102 and/or UEs 104 of FIG. 1.

In some examples, computing environment 1000 can implement one or more embodiments of the signal flow of FIG. 3 and/or the process flows of FIGS. 5-9 to facilitate coordinated compute and communication control.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1016 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a communications interface between a radio access network domain of a broadband cellular network and a compute domain;
at least one processor; and
at least one memory that stores executable instructions that, when executed by the at least one processor, facilitate performance of operations, comprising:
receiving, at the radio access network domain and via the communications interface, first information relating to operation of the broadband cellular network from the compute domain;
determining, by the radio access network domain, a near-real time action to take with respect to the operation of the broadband cellular network based on the first information and second information relating to operation of the broadband cellular network from the radio access network domain; and
implementing the near-real time action to take with respect to the operation of the broadband cellular network.

2. The system of claim 1, wherein the near-real time action to take with respect to the operation of the broadband cellular network relates to operation of the radio access network domain.

3. The system of claim 1, wherein the near-real time action to take with respect to the operation of the broadband cellular network relates to operation of the compute domain.

4. The system of claim 1, wherein the second information is received from a radio access network controller of the radio access network domain.

5. The system of claim 1, wherein the first information is received from a compute controller of the compute domain.

6. The system of claim 1, wherein the second information comprises an indication of radio frequency quality or signal quality.

7. The system of claim 1, wherein the first information comprises an indication of a performance of a computational task or a status of computing resources.

8. The system of claim 1, wherein the second information comprises a key performance indicator.

9. The system of claim 1, wherein the second information is received from an xApp in a near-real time controller of the radio access network domain.

10. A method, comprising:
obtaining, at a radio access network domain and via a communications interface of a system comprising at least one processor, first information relating to operation of a broadband cellular network from a compute domain, wherein the broadband cellular network comprises the radio access network domain, the compute domain, and the communications interface between the radio access network domain and the compute domain;
obtaining, at the radio access network domain, second information pertaining to the operation of the broadband cellular network from the radio access network domain;
determining, by the radio access network domain, an action to take with respect to the operation of the broadband cellular network based on the first information and the second information; and
in response to the determining, facilitating, by the system, performance of the action.

11. The method of claim 10, wherein the compute domain comprises a mobile edge platform.

12. The method of claim 10, wherein the second information comprises state information comprising at least one state value of the at least one first value applicable to a state of the broadband cellular network.

13. The method of claim 10, wherein the action comprises an instance of predictive resource management of the broadband cellular network.

14. The method of claim 10, wherein the action comprises selecting a computing node of the radio access network domain for deployment of an application.

15. A non-transitory computer-readable medium comprising instructions that, in response to execution, cause a system comprising at least one processor to perform operations, comprising:
obtaining, at a radio access network domain and via a communications interface, first information relating to operation of a broadband cellular network from a compute domain;
obtaining, at the radio access network domain, second information pertaining to the operation of the broadband cellular network from the radio access network domain;
determining, by the radio access network domain, an action to take with respect to the operation of the broadband cellular network based on the first information and the second information; and
initiating performance of the action with respect to the operation of the broadband cellular network.

16. The non-transitory computer-readable medium of claim 15, wherein the action comprises producing a control command via an rApp of the radio access network domain, and wherein the control command is time insensitive.

17. The non-transitory computer-readable medium of claim 15, wherein the first information comprises information about a state of the radio access network domain, and wherein the action comprises determining a location of the broadband cellular network to deploy a virtual network function based on the state of the radio access network domain.

18. The non-transitory computer-readable medium of claim 15, wherein the second information comprises information about a state of the radio access network domain, and wherein the action comprises re-routing traffic of the broadband cellular network based on the state of the radio access network domain to satisfy a reduced-latency criterion.

19. The non-transitory computer-readable medium of claim 15, wherein the second information comprises information about a state of the radio access network domain that indicates traffic that satisfies a high-traffic criterion, and wherein the action comprises allocating compute resources at a location of the radio access network domain that satisfies a network-edge criterion.

20. The non-transitory computer-readable medium of claim 15, wherein the action comprises taking a predictive action regarding the radio access network domain or the compute domain.
